(19) United States
(12) Patent Application Publication
(10) Pub. No.: US 2024/0236039 A1
(43) Pub. Date: Jul. 11, 2024

(54) SYSTEMS AND METHODS FOR REDUCING FRAME LOSS IN A NETWORK PROCESSING SYSTEM

(71) Applicant: Fortinet, Inc., Sunnyvale, CA (US)

(72) Inventor: Zainul Arif bin Mohamed, Selangor (MY)

(73) Assignee: Fortinet, Inc., Sunnyvale, CA (US)

(21) Appl. No.: 18/093,604

(22) Filed: Jan. 5, 2023

(51) Int. Cl. H04L 9/40

(52) U.S. Cl. CPC H04L 63/0227

(57) ABSTRACT

Various embodiments provide multi-path traffic filtering devices and methods for using such.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2021, Fortinet, Inc.

### FIELD

Embodiments of the present invention generally relate to network traffic filtering devices, and more particularly to systems and methods for redundant path processing in a network traffic filtering device.

### BACKGROUND

Networks are often protected by a network traffic filtering device designed to monitor network traffic being received at and sent from a local network. Problematic traffic can be disallowed, thus protecting the local network. In some cases, such a network traffic filtering device may become inoperable resulting in the loss of communications to/from the network. To avoid this, multi-node active/passive (A/P) high availability (HA) network clusters may be used where one node of the cluster takes over when another node becomes inoperable. In such a situation one of the node is active (i.e., the master node) and the other substantially inactive (i.e., the slave node). When the active node becomes inoperable it is switched to the inactive node, and the inactive node is switched to the active node. This process, while allowing the network to continue operating, often results in substantial frame losses during the transition of the inactive node to the active node.

Thus, there exists a need in the art for more advanced approaches, devices and systems for reducing frame loss in network communications due to inoperability of a network device.

### SUMMARY

Various embodiments provide multi-path traffic filtering devices and methods for using such.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIGS. 1A-1B illustrate a network architecture including a multi-path network security appliance in accordance with some embodiments;

FIG. 2 is a flow diagram showing a method in accordance with some embodiments for processing network traffic to/from a multi-path network security appliance;

FIG. 3 is a flow diagram showing a method in accordance with some embodiments for selecting an egress port of a multi-path network security appliance to source network traffic;

FIG. 4 is a flow diagram showing another method in accordance with other embodiments for selecting an egress port of a multi-path network security appliance to source network traffic;

FIG. 5 is a flow diagram showing yet another method in accordance with other embodiments for selecting an egress port of a multi-path network security appliance to source network traffic;

FIG. 6 is a flow diagram showing yet a further method in accordance with other embodiments for selecting an egress port of a multi-path network security appliance to source network traffic; and

FIG. 7 illustrates a network architecture including another multi-path network security appliance in accordance with various embodiments.

### DETAILED DESCRIPTION

Various embodiments provide multi-path traffic filtering devices and methods for using such.

Various embodiments are disclosed of a multi-path network traffic filtering device that includes at least two filter processing paths. In some instances, the network traffic filtering device is a network security appliance. At least two of the at least two filter processing paths are fully operational receiving network traffic as an input, filtering the network traffic, and providing the filtered network traffic as an output. Switches on either side of the multi-path network traffic filtering device operate to: (a) send incoming network traffic to at least two of the at least two filter processing paths of the multi-path network traffic filtering device, and (b) to forward only one output received from the at least two filter processing paths of the multi-path network traffic

Embodiments of the present disclosure include various processes, which will be described below. The processes may be performed by hardware components or may be embodied in machine-executable instructions, which may be used to cause a general-purpose or special-purpose processor programmed with the instructions to perform the steps. Alternatively, processes may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

The phrase “processing resource” is used in its broadest sense to mean one or more processors capable of executing instructions.

As used herein, a “network appliance”, a “network element”, or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform the one or more network functions. Other network devices may also include custom hardware (e.g., one or more custom Application-Specific Integrated Circuits (ASICs)). Based upon the disclosure provided herein, one of ordinary skill in the art will recognize a variety of network appliances that may be used in relation to different embodiments. In some cases, a network appliance may be a “network security appliance” or a network security device” that may reside within the particular network that it is protecting, or network security may be provided as a service with the network security device residing in the cloud. For example, while there are differences among network security device vendors, network security devices may be classified in three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines a CPU, a CP and an NP. Mid-range network security devices may include a multi-core CPU, a separate NP Application-Specific Integrated Circuits (ASIC), and a separate CP ASIC. At the high-end, network security devices may have multiple NPs and/or multiple CPs. A network security device is typically associated with a particular network (e.g., a private enterprise network) on behalf of which it provides the one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DOS attack detection and mitigation appliances).

As used herein, the phrases “network path”, “communication path”, or “network communication path” generally refer to a path whereby information may be sent from one end and received on the other. In some embodiments, such paths are referred to commonly as tunnels which are configured and provisioned as is known in the art. Such paths may traverse, but are not limited to traversing, wired or wireless communication links, wide area network (WAN) communication links, local area network (LAN) communication links, and/or combinations of the aforementioned. Based upon the disclosure provided herein, one of ordinary skill in the art will recognize a variety of communication paths and/or combinations of communication paths that may be used in relation to different embodiments.

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Example embodiments will now be described more fully hereinafter with reference to the accompanying drawings. This disclosure may, however, be embodied in many different forms and should not be construed as limited to the embodiments set forth herein. It will be appreciated by those of ordinary skill in the art that the diagrams, schematics, illustrations, and the like represent conceptual views of processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

Some embodiments provide methods for filtering network traffic. Such methods include: receiving, by a processing resource, network traffic data; providing, by the processing resource, the network traffic data to both a first traffic filter processor and a second traffic filter processor, where the first traffic filter processor generates a first filtered data set corresponding to the network traffic data, and where the second traffic filter processor generates a second filtered data set corresponding to the network traffic data; selecting, by the processing resource, one of the first filtered data set or the second filtered data set as an output data set; and transmitting, by the processing resource, the output data set to a destination of the network traffic data.

In some instances of the aforementioned embodiments, selecting the one of the first filtered data set or the second filtered data set as the output data set includes selecting, by the processing resource, the first filtered data set as the output data set when the first filtered data set is identical to the second filtered data set. In various instances of the aforementioned embodiments, the methods further include: providing, by the processing resource, the network traffic data to a third traffic filter processor, wherein the third traffic filter processor generates a third filtered data set corresponding to the network traffic data. In such instances, selecting the one of the first filtered data set or the second filtered data set as the output data set includes selecting, by the processing resource, the second filtered data set as the output data set when the first filtered data set is not identical to the third filtered data set and the second filtered data set is identical to the third filtered data set. In some cases the first traffic filter processor, the second traffic filter processor, and the third traffic filter processor are included in a multi-path network security appliance. In some such cases, selecting the one of the first filtered data set or the second filtered data set as the output data set includes selecting one of the first filtered data set, the second filtered data set, or the third filtered data set as the output data set. In such cases, the methods further include: accessing a health status of the multi-path network security appliance, wherein the health status of the multi-path network security appliance indicates a first operational status of the first traffic filter processor, a second operational status of the second traffic filter processor, and a third operational status of the third traffic filter processor; determining, by the processing resource, that the first filtered data set is not identical to the second filtered data set; determining, by the processing resource, that the first filtered data set is not identical to the third filtered data set; determining, by the processing resource, that the second filtered data set is not identical to the third filtered data set. In such cases selecting the one of the first filtered data set or the second filtered data set as the output data set includes: selecting, by the processing resource, the second filtered data set as the output data set when the first operational status indicates the first traffic filter processor is not fully operational, and the second operational status indicates the second traffic filter processor is fully operational; and selecting, by the processing resource, the third filtered data set as the output data set when the first operational status indicates the first traffic filter processor is not fully operational, and the second operational status indicates the second traffic filter processor is not fully operational.

In various instances of the aforementioned embodiments, the first traffic filter processor and the second traffic filter processor are included in a multi-path network security appliance. In such instances the methods may further include accessing a health status of the multi-path network security appliance, wherein the health status of the multi-path network security appliance indicates a first operational status of the first traffic filter processor and a second operational status of the second traffic filter processor. In some cases, selecting the one of the first filtered data set or the second filtered data set as the output data set includes: selecting, by the processing resource, the first filtered data set as the output data set when the first operational status indicates the first traffic filter processor is fully operational; and selecting, by the processing resource, the second filtered data set as the output data set when the first operational status indicates the first traffic filter processor is not fully operational, and the second operational status indicates the second traffic filter processor is fully operational. In various cases, selecting the one of the first filtered data set or the second filtered data set as the output data set includes: determining, by the processing resource, that the first filtered data set is not identical to the second filtered data set; selecting, by the processing resource, the first filtered data set as the output data set when the first operational status indicates the first traffic filter processor is fully operational; and selecting, by the processing resource, the second filtered data set as the output data set when the first operational status indicates the first traffic filter processor is not fully operational, and the second operational status indicates the second traffic filter processor is fully operational.

Other embodiments provide systems for providing multi-path network traffic filtering. Such systems include a processing resource and a non-transient computer readable medium coupled to the processing resource. The non-transient computer readable medium has stored therein instructions that when executed by the processing resource cause the processing resource to: receive network traffic data; provide the network traffic data to both a first traffic filter processor and a second traffic filter processor, where the first traffic filter processor generates a first filtered data set corresponding to the network traffic data, and where the second traffic filter processor generates a second filtered data set corresponding to the network traffic data; select one of the first filtered data set or the second filtered data set as an output data set; and transmit the output data set to a destination of the network traffic data.

Yet other embodiments provide non-transient computer readable media having stored therein instructions that when executed by a processing resource cause the processing resource to: receive network traffic data; provide the network traffic data to both a first traffic filter processor and a second traffic filter processor, where the first traffic filter processor generates a first filtered data set corresponding to the network traffic data, and where the second traffic filter processor generates a second filtered data set corresponding to the network traffic data; select one of the first filtered data set or the second filtered data set as an output data set; and transmit the output data set to a destination of the network traffic data.

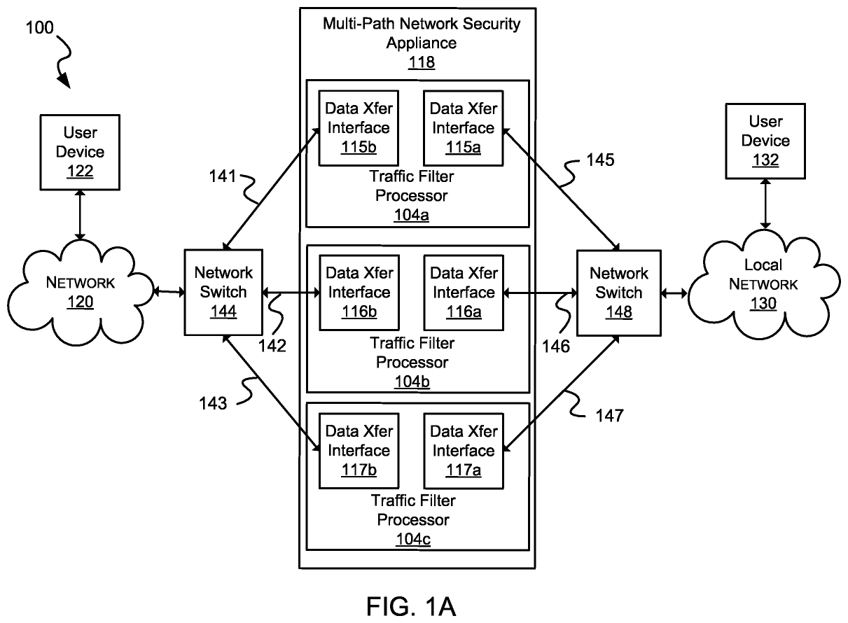

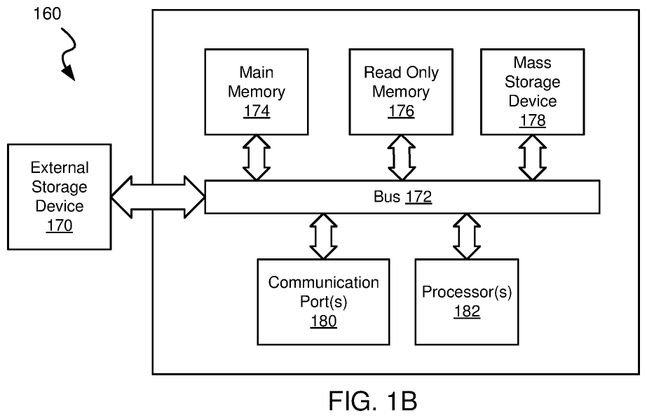

Turning to FIG. 1A, a network architecture 100 is shown in accordance with some embodiments a multi-path network security appliance 118 fed by two network switches 144, 148 in accordance with some embodiments. As shown, network architecture 100 includes a user device 122 communicably coupled to a combination of multi-path network security appliance 118 and network switches 144 via a network 120, and a user device 132 communicably coupled to the combination of multi-path network security appliance 118 and network switches 144 via a network 130.

Network 120 and network 130 may be any type of networks or combination of networks. For example, any or all of networks 120, 130 may include a combination of a home network accessed by a user device; a corporate network that connects user device 122 and/or user device 132, and/or the Internet connecting the home network to the corporate network. As another example, any or all of networks 120, 130 may be a single corporate network. Further, those skilled in the art will appreciate that any or all of networks 120, 130 can be: a wireless network, a wired network or a combination thereof that can be implemented as one of the various types of networks, such as an Intranet, a Local Area Network (LAN), a Wide Area Network (WAN), an Internet, and/or the like. Further, any or all of networks 120, 130 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like. Based upon the disclosure provided herein, one of ordinary skill in the art will recognize a variety of network types, network combinations, and/or connections that may be included as part of any or all of networks 120, 130.

User device 122 and user device 132 may be any device known in the art that is capable of communicably coupling to one or more of networks 120, 130 and sending and receiving data via the network. Such user devices may include, but are not limited to, desktop computers; mobile phones, laptop computers, or tablet computers. Based upon the disclosure provided herein, one of ordinary skill in the art will recognize a variety of endpoint devices that may be used in relation to different embodiments.

Multi-path network security appliance 118 incudes at least two traffic filter processors 104 (i.e., in this embodiment a traffic filter processor 104a, a traffic filter processor 104b, and a traffic filter processor 104c). Each of traffic filter processors 104 are configured to: (a) receive network traffic from one of network switches 144, 148, (b) to filter the network traffic to yield filtered network traffic, and (c) to provide the filtered network traffic to the other of network switches 144, 148. Any network traffic filtering processes known in the art may be performed by traffic filter processors in accordance with different embodiments including, but not limited to, firewall processing. Based upon the disclosure provided herein, one of ordinary skill in the art will recognize a variety of filtering processes that may be performed by each of traffic filter processors 104 in accordance with different embodiments.

In particular, when network traffic is received from user device 122 via network switch 144, network switch 144 provides the received network traffic to: (a) a data transfer interface 115b of traffic filter processor 104a via a network communication path 141, (b) a data transfer interface 116b of traffic filter processor 104b via a network communication path 142, and (b) a data transfer interface 117b of traffic filter processor 104c via a network communication path 143. In turn: (a) traffic filter processor 104a provides the network traffic after filtering from a data transfer interface 115a to network switch 148 via a network communication path 145, (b) traffic filter processor 104b provides the network traffic after filtering from a data transfer interface 116a to network switch 148 via a network communication path 146, and (c) traffic filter processor 104c provides the network traffic after filtering from a data transfer interface 117a to network switch 148 via a network communication path 147.

Alternatively, when network traffic is received from user device 132 via network switch 148, network switch 148 provides the received network traffic to: (a) data transfer interface 115a of traffic filter processor 104a via network communication path 145, (b) data transfer interface 116a of traffic filter processor 104b via network communication path 146, and (b) data transfer interface 117a of traffic filter processor 104c via network communication path 147. In turn: (a) traffic filter processor 104a provides the network traffic after filtering from data transfer interface 115b to network switch 144 via network communication path 141, (b) traffic filter processor 104b provides the network traffic after filtering from data transfer interface 116b to network switch 144 via network communication path 142, and (c) traffic filter processor 104c provides the network traffic after filtering from data transfer interface 117b to network switch 144 via network communication path 143.

Each of traffic filter processors 104 are configured to perform the same filtering on any received network traffic. As such, filtered network traffic provided by each of traffic filter processors 104 is identical when all of traffic filter processors 104 are fully operational. In contrast, where one of more of traffic filter processors 104 become inoperable, there will likely be differences between the filtered network traffic provided from each of the respective traffic filter processors 104.

Where a data transfer interface (e.g., data transfer interface 115, data transfer interface 116, and/or data transfer interface 117) is receiving network traffic, the data transfer interface may be referred to as an ingress for the traffic filter processor to which it is associated. In contrast, where a data transfer interface (e.g., data transfer interface 115, data transfer interface 116, and/or data transfer interface 117) is providing network traffic, the data transfer interface may be referred to as an egress for the traffic filter processor to which it is associated. Thus, the same data transfer interface may be both an ingress or egress with the difference being the current function being provided by the respective data transfer interface.

Each of network switches 144, 148 perform the same functions, and in some embodiments are identical devices. Network switches 144, 148 provide for routing network traffic destined for a local network protected by multi-path network security appliance 118 to at least two traffic filter processors 104 of multi-path network security appliance 118. Such an approach provides redundancy such that if one of the traffic filter processors 104 of multi-path network security appliance 118 becomes inoperable, another of the traffic filter processors 104 of multi-path network security appliance 118 will perform any desired traffic filtering and provide a filtered output.

Alternatively, when network traffic is received by either of network switches 144, 148, the respective network switch selects one of the traffic filter processors 104 from which filtered network traffic will be forwarded and disregards network traffic from any other of the traffic filter processors 104. In this way, only one set of network traffic is forwarded to an identified destination.

In some embodiments, the combination of multi-path network security appliance 118 and network switches 144, 148 determines whether a frame of network traffic has been received from multi-path security appliance 118. As just some examples, such network traffic may be received by network switch 144 from user device 122, or received by network switch 148 from user device 132. Based upon the disclosure provided herein, one of ordinary skill in the art will recognize a variety of sources other than a multi-path network security appliance from which network traffic may be received.

Where it is determined that a frame of network traffic has been received from other than multi-path security appliance 118, it is determined whether the frame of network traffic is destined for a local network protected by multi-path network security appliance 118. Where the received frame of network traffic is not destined for a multi-path network security appliance 118, the frame of network traffic is transferred to the single destination address. Such a transfer to a single destination address is simply a standard forwarding of network traffic by a network switch.

Alternatively, where the received frame of network traffic is destined for multi-path network security appliance 118, the frame of network traffic is transferred to N ingress ports (e.g., to each traffic filter processor) in multi-path network security appliance 118 designated for receiving replicated network traffic. N is the number of traffic filter processors included in the multi-path network processor that are configured to process the incoming network traffic. In this embodiment N is three, but fewer or more traffic filter processors may be used in relation to different embodiments. The same frame of network traffic is identically transferred (i.e., in the same sequence) to each of the N ingress ports.

Multi-path network security appliance 118 is configured to process each of the duplicate network traffic sets independently in respective traffic filter processors. Each of the traffic filter processors 104 operate as if it is the only traffic filter processor operating on the received network traffic set. In some embodiments, each of the traffic filter processors 104 is aware of other traffic filter processors within multi-path network security appliance 118, but this does not change how the respective traffic filter processors 104 operate on the received network traffic set. The awareness provided to each of the respective traffic filter processors 104 may be, for example, of an overall state of operation of multi-path network security appliance 118 and/or a state of operation of each of the respective traffic filter processors 104.

Such an approach of processing multiple duplicates of network traffic reduces an amount of traffic lost when compared to, for example, a standard multi-node network device where a failover process is sub-second in speed where a user diagram protocol (UDP) frame is lost. Similarly, such an approach of processing multiple duplicates of network traffic reduces an amount of traffic lost when compared to, for example, standard load balancing approaches which require a health check to trigger a failure before the load is transferred to another node and the other node must be brought up to speed resulting in lost data during the load transition time.

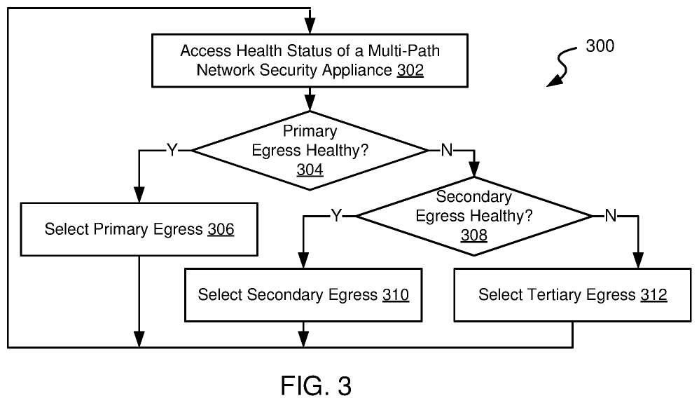

On the other hand, where it is determined that a frame of network traffic has been received from multi-path security appliance 118, an egress from one of traffic filter processors 104 of multi-path security appliance 118 is selected. The selected egress is selected in accordance with a selection protocol incorporating filter path failure considerations. Various example of such selection protocols are discussed below in relation to FIGS. 3-6. With the egress selected (i.e., traffic filter processor 104 of the network security appliance is selected), the frame of traffic having been processed is transferred from the selected egress to a single destination address.

Turning to FIG. 1B, an example computer system 160 in which or with which embodiments of the present invention may be utilized is shown. In some case, one or more of user devices 122, 132, network switches 144, 148, and/or traffic filter processors 104 may be implemented to include the features of example computer system 160. As shown in FIG. 1B, computer system 160 includes an external storage device 170, a bus 172, a main memory 174, a read-only memory 176, a mass storage device 178, a communication port 180, and one or more processors 182.

Those skilled in the art will appreciate that computer system 160 may include more than one processor 182 and communication ports 180. Examples of processor 1820 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 182 may include various modules associated with embodiments of the present invention.

Communication port 180 can be any of an RS-232 port for use with a modem-based dialup connection, a 10/100 Ethernet port, a Gigabit or 10 Gigabit port using copper or fiber, a serial port, a parallel port, or other existing or future ports. Communication port 180 may be chosen depending on a network, such as a Local Area Network (LAN), Wide Area Network (WAN), or any network to which the computer system connects.

Memory 174 can be Random Access Memory (RAM), or any other dynamic storage device commonly known in the art. Read-Only Memory 176 can be any static storage device(s) e.g., but not limited to, a Programmable Read-Only Memory (PROM) chips for storing static information e.g. start-up or BIOS instructions for processor 182.

Mass storage 178 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 172 communicatively couples processor(s) 182 with the other memory, storage, and communication blocks. Bus 172 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 182 to a software system.

Optionally, operator and administrative interfaces, e.g. a display, keyboard, and a cursor control device, may also be coupled to bus 172 to support direct operator interaction with the computer system. Other operator and administrative interfaces can be provided through network connections connected through communication port 180. An external storage device 170 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned example computer system limit the scope of the present disclosure.

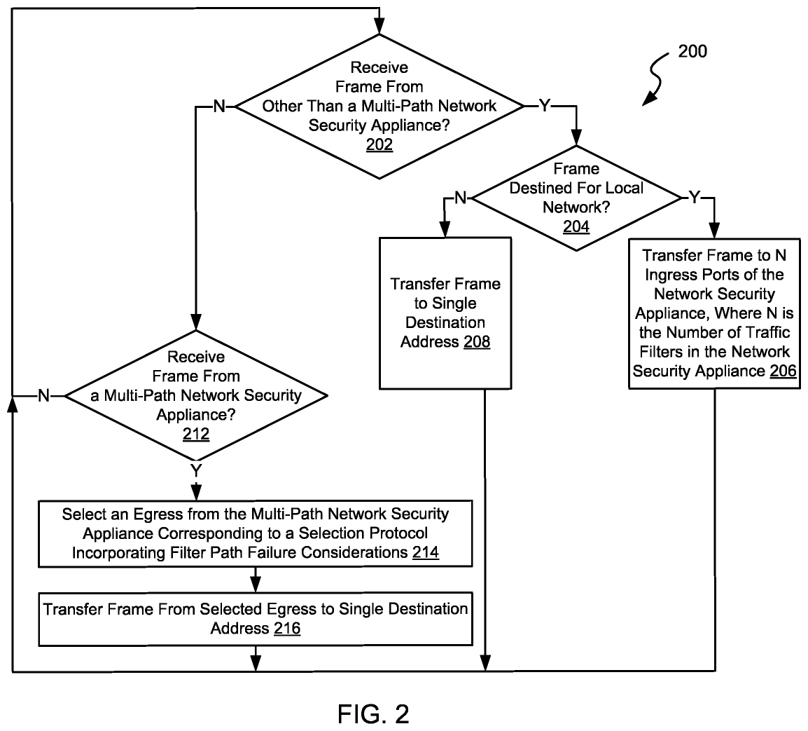

Turning to FIG. 2, a flow diagram 200 shows a method in accordance with some embodiments for processing network traffic to/from a multi-path network security appliance. Following flow diagram 200, it is determined whether a frame of network traffic has been received from other than a multi-path security appliance (block 202). As just some examples, such network traffic may be received by network switch 144 from user device 122, or received by network switch 148 from user device 132. Based upon the disclosure provided herein, one of ordinary skill in the art will recognize a variety of sources other than a multi-path network security appliance from which network traffic may be received.

Where it is determined that a frame of network traffic has been received from other than a multi-path security appliance (block 202), it is determined whether the frame of network traffic is destined for a local network protected by a multi-path network security appliance (block 204). Where the received frame of network traffic is not destined for a multi-path network security appliance (block 204), the frame of network traffic is transferred to the single destination address (block 208). Such a transfer to a single destination address is simply a standard forwarding of network traffic by a network switch.

Alternatively, where the received frame of network traffic is destined for a multi-path network security appliance (block 204), the frame of network traffic is transferred to N ingress ports (e.g., to each traffic filter processor) in the multi-path network security appliance designated for receiving replicated network traffic (block 206). N is the number of traffic filter processors included in the multi-path network processor that are configured to process the incoming network traffic. The same frame of network traffic is identically transferred (i.e., in the same sequence) to each of the N ingress ports.

The multi-path network security appliance is configured to process each of the duplicate network traffic sets independently in respective traffic filter processors. Each of the traffic filter processors operate as if it is the only traffic filter processor operating on the received network traffic set. In some embodiments, each of the traffic filter processors is aware of other traffic filter processors within the multi-path network security appliance, but this does not change how the respective traffic filter processors operate on the received network traffic set. The awareness provided to each of the respective traffic filter processors may be, for example, of an overall state of operation of the multi-path network security appliance and/or a state of operation of each of the respective traffic filter processors.

Such an approach of processing multiple duplicates of network traffic reduces an amount of traffic lost when compared to, for example, a standard multi-node network device where a failover process is sub-second in speed where a UDP frame is lost. Similarly, such an approach of processing multiple duplicates of network traffic reduces an amount of traffic lost when compared to, for example, standard load balancing approaches which require a health check to trigger a failure before the load is transferred to another node and the other node must be brought up to speed resulting in lost data during the load transition time.

Alternatively, where it is determined that a frame of network traffic has not been received from other than a multi-path security appliance (block 202), it is determined whether a frame of network traffic has been received from a multi-path security appliance (block 212). Where it is determined that no frame has been received (block 202 and block 212), the processes are repeated as receipt of a frame is awaited.

On the other hand, where it is determined that a frame of network traffic has been received from a multi-path security appliance (block 212), an egress from one of the traffic filter processors of the multi-path security appliance is selected (block 214). The selected egress is selected in accordance with a selection protocol incorporating filter path failure considerations. Various example of such selection protocols are discussed below in relation to FIGS. 3-6. It is noted that while FIGS. 3-6 are configured to select between egresses from three different traffic filter processors, the methods may be modified to provide for selection between two and/or four or more egresses from three different traffic filter processors depending upon the particular implementation. With the egress selected (i.e., the traffic filter processor of the network security appliance is selected) (block 214), the frame of traffic having been processed is transferred from the selected egress to a single destination address (block 216).

Turning to FIG. 3, a flow diagram 300 shows a method in accordance with some embodiments for selecting an egress port of a multi-path network security appliance to source network traffic. In some embodiments, the method of flow diagram 300 may be used to perform the selection process described above in relation to block 214 of FIG. 2. Following flow diagram 300, a health status of a multi-path network security appliance is accessed (block 302). This health status in part indicates the health status of each of the traffic filter processors of the multi-path network security appliance. In such a case, one of the traffic filter processors may be identified as including a primary egress, another of the traffic filter processors may be identified as including a secondary egress, and yet another of the traffic filter processors may be identified as including a tertiary egress.

It is determined whether the primary egress is healthy (i.e., whether the traffic filter processor including the primary egress is healthy) (block 304). Where the primary egress is healthy (block 304), the primary egress is selected (block 306). Otherwise, where the primary egress is not healthy (block 304), it is determined whether the secondary egress is healthy (i.e., whether the traffic filter processor including the secondary egress is healthy) (block 308). Where the secondary egress is healthy (block 308), the secondary egress is selected (block 310). Otherwise, where the secondary egress is not healthy (block 308), the tertiary egress is selected (block 312).

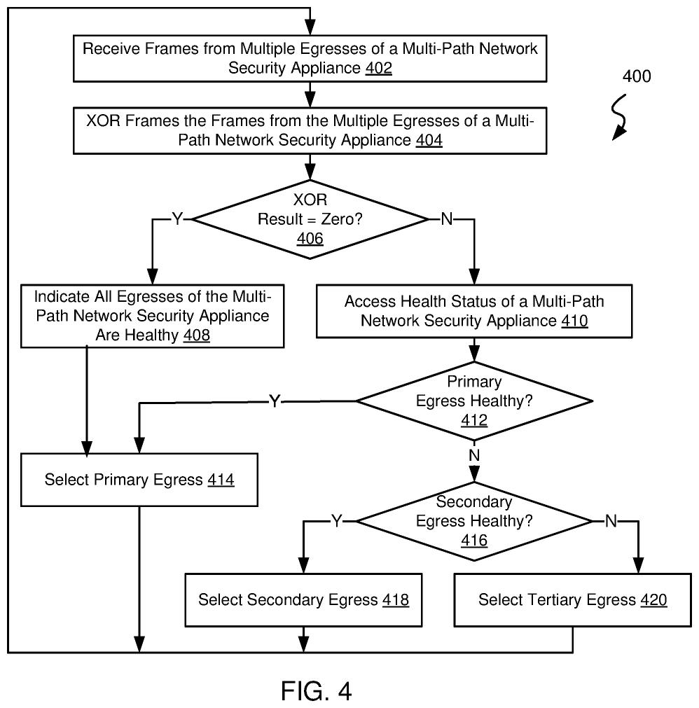

Turning to FIG. 4, a flow diagram 400 shows another method in accordance with other embodiments for selecting an egress port of a multi-path network security appliance to source network traffic. In some embodiments, the method of flow diagram 400 may be used to perform the selection process described above in relation to block 214 of FIG. 2. In the method, one of the traffic filter processors may be identified as including a primary egress, another of the traffic filter processors may be identified as including a secondary egress, and yet another of the traffic filter processors may be identified as including a tertiary egress. Following flow diagram 400, duplicates of a frame of network traffic are received from multiple egresses (i.e., from multiple traffic filter processors) of a multi-path network security appliance (block 402). A multipart XOR is applied to all of the received duplicate frames of network traffic such that where all of the duplicate frames are identical the multipart XOR yields a zero value, or returns a non-zero value when any of the duplicate frames differ from another of the duplicate frames (block 404).

The returned zero value from the multipart XOR indicates that all of the received duplicate frames of network traffic are identical, and as such selecting any of the duplicate frames will yield the same forwarding frame (block 406). Where the returned value from the multipart XOR is zero (block 406), a status indicates that all egresses of the multi-path network security appliance are healthy (block 408), and the primary egress is selected (block 414).

Alternatively, where the value returned from the multipart XOR is non-zero (block 406), it indicates that at least one of the received duplicate frames includes an error indicative of a failure of the multiple traffic filter processor including the egress that provided the frame of network traffic. Where the returned value from the multipart XOR is non-zero (block 406), a health status of the multi-path network security appliance is accessed (block 410). This health status in part indicates the health status of each of the traffic filter processors of the multi-path network security appliance.

It is determined whether the primary egress is healthy (i.e., whether the traffic filter processor including the primary egress is healthy) (block 412). Where the primary egress is healthy (block 412), the primary egress is selected (block 414). Otherwise, where the primary egress is not healthy (block 412), it is determined whether the secondary egress is healthy (i.e., whether the traffic filter processor including the secondary egress is healthy) (block 416). Where the secondary egress is healthy (block 416), the secondary egress is selected (block 418). Otherwise, where the secondary egress is not healthy (block 416), the tertiary egress is selected (block 420).

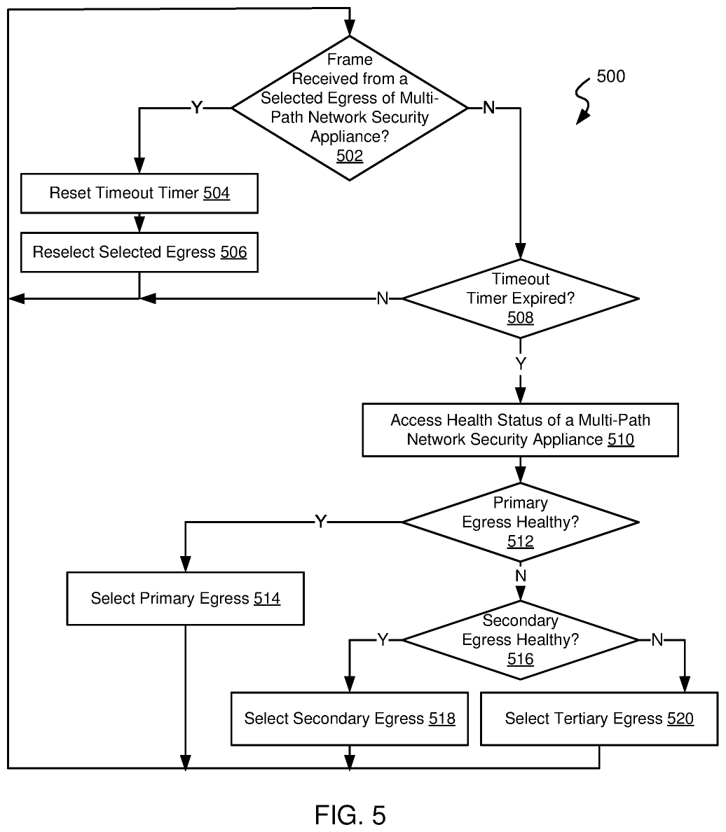

Turning to FIG. 5, a flow diagram 500 shows yet another method in accordance with other embodiments for selecting an egress port of a multi-path network security appliance to source network traffic. In some embodiments, the method of flow diagram 500 may be used to perform the selection process described above in relation to block 214 of FIG. 2. In the method, one of the traffic filter processors may be identified as including a primary egress, another of the traffic filter processors may be identified as including a secondary egress, and yet another of the traffic filter processors may be identified as including a tertiary egress. Following flow diagram 500, it is determined whether a frame of network traffic has been received from the selected egress of a multi-path network security appliance (block 502). Where a frame of network traffic has been received (block 502), a timeout timer is reset (block 504), and the selected egress is reselected (i.e., there is no change in which egress is providing forwarded frames)(block 506).

Alternatively, where a frame of network traffic has not been received (block 502), it is determined whether the timeout timer has expired (block 508). The timeout timer may expire when a user programmable amount of time has passed. The user programmable amount of time may be selected as a time greater than that which would normally be expected between frames of network traffic. Based upon the disclosure provided herein, one of ordinary skill in the art will recognize a variety of times that may be used for the timeout timer in accordance with different embodiments. Where time timeout timer has not expired (block 508), the process returns to block 502.

Alternatively, where time timeout timer has expired (block 508), it suggests a potential failure of the selected egress (i.e., the traffic filter processor including the selected egress). In such a case (block 508), a health status of the multi-path network security appliance is accessed (block 510). This health status in part indicates the health status of each of the traffic filter processors of the multi-path network security appliance.

It is determined whether the primary egress is healthy (i.e., whether the traffic filter processor including the primary egress is healthy) (block 512). Where the primary egress is healthy (block 512), the primary egress is selected (block 514). Otherwise, where the primary egress is not healthy (block 512), it is determined whether the secondary egress is healthy (i.e., whether the traffic filter processor including the secondary egress is healthy) (block 516). Where the secondary egress is healthy (block 516), the secondary egress is selected (block 518). Otherwise, where the secondary egress is not healthy (block 516), the tertiary egress is selected (block 520).

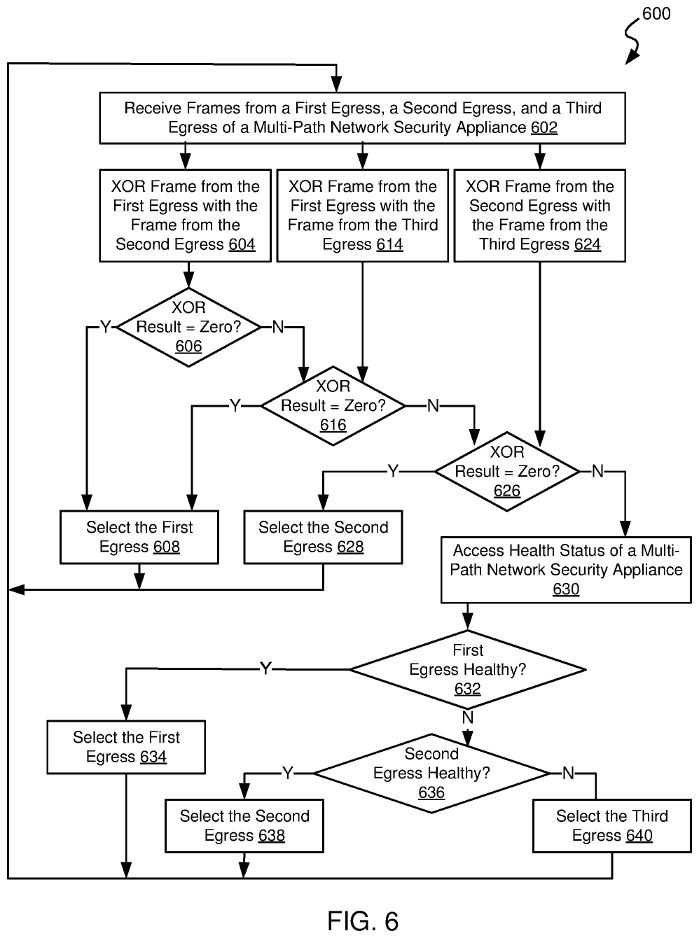

Turning to FIG. 6, a flow diagram 600 shows yet a further method in accordance with other embodiments for selecting an egress port of a multi-path network security appliance to source network traffic. In some embodiments, the method of flow diagram 600 may be used to perform the selection process described above in relation to block 214 of FIG. 2. Following flow diagram 600, duplicates of a frame of network traffic are received from multiple egresses (i.e., from multiple traffic filter processors) of a multi-path network security appliance (block 602). In this embodiment, a multi-path network security appliance having three traffic filter processors is used with: one of the traffic filter processors may be identified as including a first egress, another of the traffic filter processors may be identified as including a second egress, and yet another of the traffic filter processors may be identified as including a third egress. It is noted that the method may be expanded to handle four or more traffic filter processors and corresponding egresses.

The frame of network traffic received from the first egress is logically XOR'd with the frame of network traffic received from the second egress (block 604); the frame of network traffic received from the first egress is logically XOR'd with the frame of network traffic received from the third egress (block 614); and the frame of network traffic received from the second egress is logically XOR'd with the frame of network traffic received from the third egress (block 624). Where the returned value from the logical XOR of the frame of network traffic received from the first egress and the frame of network traffic received from the second egress is zero (block 606), it is assumed that the first egress is healthy as it is generating the same filtered frame of network traffic as the second egress. In such a case (block 606), the first egress is selected (block 608).

Alternatively, where the returned value from the logical XOR of the frame of network traffic received from the first egress and the frame of network traffic received from the second egress is non-zero (block 606), it is assumed that there is a problem with one or both of the first egress and/or the second egress because of the difference in the provided filtered frame of network traffic from each. In such a case (block 606), it is determined whether the returned value from the logical XOR of the frame of network traffic received from the first egress and the frame of network traffic received from the third egress is zero (block 616). Where the returned value from the logical XOR of the frame of network traffic received from the first egress and the frame of network traffic received from the third egress is zero (block 616), it is assumed that the first egress is healthy as it is generating the same filtered frame of network traffic as the third egress. In such a case (block 616), the first egress is selected (block 608).

Alternatively, where the returned value from the logical XOR of the frame of network traffic received from the first egress and the frame of network traffic received from the third egress is non-zero (block 616), it is assumed that there is a problem with one or both of the first egress and/or the third egress because of the difference in the provided filtered frame of network traffic from each. In such a case (block 616), it is determined whether the returned value from the logical XOR of the frame of network traffic received from the second egress and the frame of network traffic received from the third egress is zero (block 626). Where the returned value from the logical XOR of the frame of network traffic received from the second egress and the frame of network traffic received from the third egress is zero (block 626), it is assumed that the second egress is healthy as it is generating the same filtered frame of network traffic as the third egress. In such a case (block 626), the second egress is selected (block 628).

Alternatively, where the returned value from the logical XOR of the frame of network traffic received from the second egress and the frame of network traffic received from the third egress is non-zero (block 626), it is assumed that there is a problem with at least two of the first egress, the second egress, and/or the third egress because of the difference in the provided filtered frame of network traffic from each. In such a case (block 626), a health status of the multi-path network security appliance is accessed (block 630). This health status in part indicates the health status of each of the traffic filter processors of the multi-path network security appliance.

It is determined whether the first egress is healthy (i.e., whether the traffic filter processor including the first egress is healthy) (block 632). Where the first egress is healthy (block 632), the first egress is selected (block 634). Otherwise, where the first egress is not healthy (block 632), it is determined whether the second egress is healthy (i.e., whether the traffic filter processor including the second egress is healthy) (block 636). Where the second egress is healthy (block 636), the second egress is selected (block 638). Otherwise, where the second egress is not healthy (block 636), the third egress is selected (block 640).

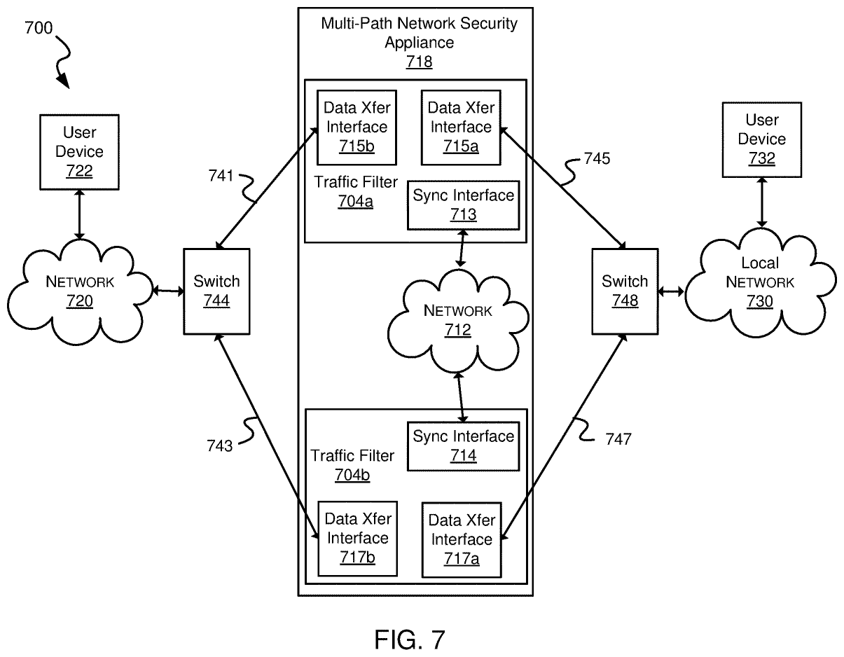

FIG. 7 illustrates a network architecture 700 including another multi-path network security appliance 718 in accordance with various embodiments. As shown, network architecture 700 includes a user device 722 communicably coupled to a combination of multi-path network security appliance 718 and network switches 744 via a network 720, and a user device 732 communicably coupled to the combination of multi-path network security appliance 718 and network switches 744 via a network 730.

Network 720 and network 730 may be any type of networks or combination of networks. For example, any or all of networks 720, 730 may include a combination of a home network accessed by a user device; a corporate network that connects user device 722 and/or user device 732, and/or the Internet connecting the home network to the corporate network. As another example, any or all of networks 720, 730 may be a single corporate network. Further, those skilled in the art will appreciate that any or all of networks 720, 730 can be: a wireless network, a wired network or a combination thereof that can be implemented as one of the various types of networks, such as an Intranet, a Local Area Network (LAN), a Wide Area Network (WAN), an Internet, and/or the like. Further, any or all of networks 720, 730 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like. Based upon the disclosure provided herein, one of ordinary skill in the art will recognize a variety of network types, network combinations, and/or connections that may be included as part of any or all of networks 720, 730.

User device 722 and user device 732 may be any device known in the art that is capable of communicably coupling to one or more of networks 720, 730 and sending and receiving data via the network. Such user devices may include, but are not limited to, desktop computers; mobile phones, laptop computers, or tablet computers. Based upon the disclosure provided herein, one of ordinary skill in the art will recognize a variety of endpoint devices that may be used in relation to different embodiments.

Multi-path network security appliance 718 incudes at least two traffic filter processors 704 (i.e., in this embodiment a traffic filter processor 704a, and a traffic filter processor 704b). Each of traffic filter processors 704 are configured to: (a) receive network traffic from one of network switches 744, 748, (b) to filter the network traffic to yield filtered network traffic, and (c) to provide the filtered network traffic to the other of network switches 744, 748. Any network traffic filtering processes known in the art may be performed by traffic filter processors in accordance with different embodiments including, but not limited to, firewall processing. Based upon the disclosure provided herein, one of ordinary skill in the art will recognize a variety of filtering processes that may be performed by each of traffic filter processors 704 in accordance with different embodiments.

Traffic filter processor 704a includes a sync interface 713 and traffic filter processor 704b includes a sync interface 712. Traffic filter processors 704 can communicate via sync interfaces 713, 714 and a network 712. In this way, traffic filter processors 704 can be aware of the operational status of other traffic filter processors.

When network traffic is received from user device 722 via network switch 744, network switch 744 provides the received network traffic to: (a) a data transfer interface 715b of traffic filter processor 704a via a network communication path 741, (b) a data transfer interface 716b of traffic filter processor 704b via a network communication path 742, and (b) a data transfer interface 717b of traffic filter processor 704c via a network communication path 743. In turn: (a) traffic filter processor 704a provides the network traffic after filtering from a data transfer interface 715a to network switch 748 via a network communication path 745, (b) traffic filter processor 704b provides the network traffic after filtering from a data transfer interface 716a to network switch 748 via a network communication path 746, and (c) traffic filter processor 704c provides the network traffic after filtering from a data transfer interface 717a to network switch 748 via a network communication path 747.

Alternatively, when network traffic is received from user device 732 via network switch 748, network switch 748 provides the received network traffic to: (a) data transfer interface 715a of traffic filter processor 704a via network communication path 745, (b) data transfer interface 716a of traffic filter processor 704b via network communication path 746, and (b) data transfer interface 717a of traffic filter processor 704c via network communication path 747. In turn: (a) traffic filter processor 704a provides the network traffic after filtering from data transfer interface 715b to network switch 744 via network communication path 741, (b) traffic filter processor 704b provides the network traffic after filtering from data transfer interface 716b to network switch 744 via network communication path 742, and (c) traffic filter processor 704c provides the network traffic after filtering from data transfer interface 717b to network switch 744 via network communication path 743.

Each of traffic filter processors 704 are configured to perform the same filtering on any received network traffic. As such, filtered network traffic provided by each of traffic filter processors 704 is identical when all of traffic filter processors 704 are fully operational. In contrast, where one of more of traffic filter processors 704 become inoperable, there will likely be differences between the filtered network traffic provided from each of the respective traffic filter processors 704.

Where a data transfer interface (e.g., data transfer interface 715, data transfer interface 716, and/or data transfer interface 717) is receiving network traffic, the data transfer interface may be referred to as an ingress for the traffic filter processor to which it is associated. In contrast, where a data transfer interface (e.g., data transfer interface 715, data transfer interface 716, and/or data transfer interface 717) is providing network traffic, the data transfer interface may be referred to as an egress for the traffic filter processor to which it is associated. Thus, the same data transfer interface may be both an ingress or egress with the difference being the current function being provided by the respective data transfer interface.

Each of network switches 744, 748 perform the same functions, and in some embodiments are identical devices. Network switches 744, 748 provide for routing network traffic destined for a local network protected by multi-path network security appliance 718 to at least two traffic filter processors 704 of multi-path network security appliance 718. Such an approach provides redundancy such that if one of the traffic filter processors 704 of multi-path network security appliance 718 becomes inoperable, another of the traffic filter processors 704 of multi-path network security appliance 718 will perform any desired traffic filtering and provide a filtered output.

Alternatively, when network traffic is received by either of network switches 744, 748, the respective network switch selects one of the traffic filter processors 704 from which filtered network traffic will be forwarded and disregards network traffic from any other of the traffic filter processors 704. In this way, only one set of network traffic is forwarded to an identified destination.

In conclusion, the present invention provides for novel systems, devices, and methods. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for filtering network traffic, the method comprising:
receiving, by a processing resource, network traffic data;
providing, by the processing resource, the network traffic data to both a first traffic filter processor and a second traffic filter processor, wherein the first traffic filter processor generates a first filtered data set corresponding to the network traffic data, and wherein the second traffic filter processor generates a second filtered data set corresponding to the network traffic data;
selecting, by the processing resource, one of the first filtered data set or the second filtered data set as an output data set; and
transmitting, by the processing resource, the output data set to a destination of the network traffic data.

2. The method of claim 1, wherein selecting the one of the first filtered data set or the second filtered data set as the output data set includes:
selecting, by the processing resource, the first filtered data set as the output data set when the first filtered data set is identical to the second filtered data set.

3. The method of claim 1, the method further comprising:
providing, by the processing resource, the network traffic data to a third traffic filter processor, wherein the third traffic filter processor generates a third filtered data set corresponding to the network traffic data; and
wherein the selecting the one of the first filtered data set or the second filtered data set as the output data set includes selecting, by the processing resource, the second filtered data set as the output data set when the first filtered data set is not identical to the third filtered data set and the second filtered data set is identical to the third filtered data set.

4. The method of claim 3, wherein the first traffic filter processor, the second traffic filter processor, and the third traffic filter processor are included in a multi-path network security appliance; wherein selecting the one of the first filtered data set or the second filtered data set as the output data set includes selecting one of the first filtered data set, the second filtered data set, or the third filtered data set as the output data set; and wherein the method further includes:
accessing a health status of the multi-path network security appliance, wherein the health status of the multi-path network security appliance indicates a first operational status of the first traffic filter processor, a second operational status of the second traffic filter processor, and a third operational status of the third traffic filter processor;
determining, by the processing resource, that the first filtered data set is not identical to the second filtered data set;
determining, by the processing resource, that the first filtered data set is not identical to the third filtered data set;
determining, by the processing resource, that the second filtered data set is not identical to the third filtered data set;
wherein selecting the one of the first filtered data set or the second filtered data set as the output data set includes:
selecting, by the processing resource, the second filtered data set as the output data set when the first operational status indicates the first traffic filter processor is not fully operational, and the second operational status indicates the second traffic filter processor is fully operational; and
selecting, by the processing resource, the third filtered data set as the output data set when the first operational status indicates the first traffic filter processor is not fully operational, and the second operational status indicates the second traffic filter processor is not fully operational.

5. The method of claim 1, wherein the first traffic filter processor and the second traffic filter processor are included in a multi-path network security appliance, and wherein the method further includes:
accessing a health status of the multi-path network security appliance, wherein the health status of the multi-path network security appliance indicates a first operational status of the first traffic filter processor and a second operational status of the second traffic filter processor.

6. The method of claim 5, wherein selecting the one of the first filtered data set or the second filtered data set as the output data set includes:
selecting, by the processing resource, the first filtered data set as the output data set when the first operational status indicates the first traffic filter processor is fully operational; and
selecting, by the processing resource, the second filtered data set as the output data set when the first operational status indicates the first traffic filter processor is not fully operational, and the second operational status indicates the second traffic filter processor is fully operational.

7. The method of claim 5, wherein selecting the one of the first filtered data set or the second filtered data set as the output data set includes:
determining, by the processing resource, that the first filtered data set is not identical to the second filtered data set;
selecting, by the processing resource, the first filtered data set as the output data set when the first operational status indicates the first traffic filter processor is fully operational; and
selecting, by the processing resource, the second filtered data set as the output data set when the first operational status indicates the first traffic filter processor is not fully operational, and the second operational status indicates the second traffic filter processor is fully operational.

8. A system for providing multi-path network traffic filtering, the system comprising:
a processing resource;
a non-transient computer readable medium coupled to the processing resource and having stored therein instructions that when executed by the processing resource cause the processing resource to:
receive network traffic data;
provide the network traffic data to both a first traffic filter processor and a second traffic filter processor, wherein the first traffic filter processor generates a first filtered data set corresponding to the network traffic data, and wherein the second traffic filter processor generates a second filtered data set corresponding to the network traffic data;
select one of the first filtered data set or the second filtered data set as an output data set; and
transmit the output data set to a destination of the network traffic data.

9. The system of claim 8, wherein selecting the one of the first filtered data set or the second filtered data set as the output data set includes:
selecting the first filtered data set as the output data set when the first filtered data set is identical to the second filtered data set.

10. The system of claim 8, wherein the non-transient computer readable medium further has stored therein instructions that when executed by the processing resource cause the processing resource to:
provide the network traffic data to a third traffic filter processor, wherein the third traffic filter processor generates a third filtered data set corresponding to the network traffic data; and
wherein the selecting the one of the first filtered data set or the second filtered data set as the output data set includes selecting, by the processing resource, the second filtered data set as the output data set when the first filtered data set is not identical to the third filtered data set and the second filtered data set is identical to the third filtered data set.

11. The system of claim 10, wherein the first traffic filter processor, the second traffic filter processor, and the third traffic filter processor are included in a multi-path network security appliance; wherein selecting the one of the first filtered data set or the second filtered data set as the output data set includes selecting one of the first filtered data set, the second filtered data set, or the third filtered data set as the output data set; and wherein the non-transient computer readable medium further has stored therein instructions that when executed by the processing resource cause the processing resource to:
access a health status of the multi-path network security appliance, wherein the health status of the multi-path network security appliance indicates a first operational status of the first traffic filter processor, a second operational status of the second traffic filter processor, and a third operational status of the third traffic filter processor;
determine, that the first filtered data set is not identical to the second filtered data set;
determine that the first filtered data set is not identical to the third filtered data set;
determine that the second filtered data set is not identical to the third filtered data set;
wherein selecting the one of the first filtered data set or the second filtered data set as the output data set includes:
selecting, by the processing resource, the second filtered data set as the output data set when the first operational status indicates the first traffic filter processor is not fully operational, and the second operational status indicates the second traffic filter processor is fully operational; and
selecting, by the processing resource, the third filtered data set as the output data set when the first operational status indicates the first traffic filter processor is not fully operational, and the second operational status indicates the second traffic filter processor is not fully operational.

12. The system of claim 8, wherein the first traffic filter processor and the second traffic filter processor are included in a multi-path network security appliance, and wherein the non-transient computer readable medium further has stored therein instructions that when executed by the processing resource cause the processing resource to:
access a health status of the multi-path network security appliance, wherein the health status of the multi-path network security appliance indicates a first operational status of the first traffic filter processor and a second operational status of the second traffic filter processor.

13. The system of claim 12, wherein selecting the one of the first filtered data set or the second filtered data set as the output data set includes:
selecting the first filtered data set as the output data set when the first operational status indicates the first traffic filter processor is fully operational; and
selecting the second filtered data set as the output data set when the first operational status indicates the first traffic filter processor is not fully operational, and the second operational status indicates the second traffic filter processor is fully operational.

14. The system of claim 12, wherein the instructions executable by the processing resource to select the one of the first filtered data set or the second filtered data set as the output data set are executable by the processing resource to:
determine that the first filtered data set is not identical to the second filtered data set;
select the first filtered data set as the output data set when the first operational status indicates the first traffic filter processor is fully operational; and
select the second filtered data set as the output data set when the first operational status indicates the first traffic filter processor is not fully operational, and the second operational status indicates the second traffic filter processor is fully operational.

15. A non-transient computer readable medium having stored therein instructions that when executed by a processing resource cause the processing resource to:
receive network traffic data;
provide the network traffic data to both a first traffic filter processor and a second traffic filter processor, wherein the first traffic filter processor generates a first filtered data set corresponding to the network traffic data, and wherein the second traffic filter processor generates a second filtered data set corresponding to the network traffic data;
select one of the first filtered data set or the second filtered data set as an output data set; and
transmit the output data set to a destination of the network traffic data.

16. The non-transient computer readable medium of claim 15, wherein selecting the one of the first filtered data set or the second filtered data set as the output data set includes:
selecting the first filtered data set as the output data set when the first filtered data set is identical to the second filtered data set.

17. The non-transient computer readable medium of claim 15, wherein the non-transient computer readable medium further has stored therein instructions that when executed by the processing resource cause the processing resource to:
provide the network traffic data to a third traffic filter processor, wherein the third traffic filter processor generates a third filtered data set corresponding to the network traffic data; and
wherein the selecting the one of the first filtered data set or the second filtered data set as the output data set includes selecting, by the processing resource, the second filtered data set as the output data set when the first filtered data set is not identical to the third filtered data set and the second filtered data set is identical to the third filtered data set.

18. The non-transient computer readable medium of claim 17, wherein the first traffic filter processor, the second traffic filter processor, and the third traffic filter processor are included in a multi-path network security appliance; wherein selecting the one of the first filtered data set or the second filtered data set as the output data set includes selecting one of the first filtered data set, the second filtered data set, or the third filtered data set as the output data set; and wherein the non-transient computer readable medium further has stored therein instructions that when executed by the processing resource cause the processing resource to:
access a health status of the multi-path network security appliance, wherein the health status of the multi-path network security appliance indicates a first operational status of the first traffic filter processor, a second operational status of the second traffic filter processor, and a third operational status of the third traffic filter processor;
determine, that the first filtered data set is not identical to the second filtered data set;
determine that the first filtered data set is not identical to the third filtered data set;
determine that the second filtered data set is not identical to the third filtered data set;
wherein selecting the one of the first filtered data set or the second filtered data set as the output data set includes:
selecting, by the processing resource, the second filtered data set as the output data set when the first operational status indicates the first traffic filter processor is not fully operational, and the second operational status indicates the second traffic filter processor is fully operational; and
selecting, by the processing resource, the third filtered data set as the output data set when the first operational status indicates the first traffic filter processor is not fully operational, and the second operational status indicates the second traffic filter processor is not fully operational.

19. The non-transient computer readable medium of claim 15, wherein the first traffic filter processor and the second traffic filter processor are included in a multi-path network security appliance, and wherein the non-transient computer readable medium further has stored therein instructions that when executed by the processing resource cause the processing resource to:
access a health status of the multi-path network security appliance, wherein the health status of the multi-path network security appliance indicates a first operational status of the first traffic filter processor and a second operational status of the second traffic filter processor.

20. The non-transient computer readable medium of claim 19, wherein selecting the one of the first filtered data set or the second filtered data set as the output data set includes:
selecting the first filtered data set as the output data set when the first operational status indicates the first traffic filter processor is fully operational; and
selecting the second filtered data set as the output data set when the first operational status indicates the first traffic filter processor is not fully operational, and the second operational status indicates the second traffic filter processor is fully operational.
